(19) United States
(12) Patent Application Publication
(10) Pub. No.: US 2002/0034676 A1
(43) Pub. Date: Mar. 21, 2002

(54) Method of fabricating catalyzed porous carbon electrode for fuel cell

(76) Inventors: Dong-Il Kim, Chungcheongbuk-do (KR); Chang-Hyeong Lee, Chungcheongbuk-do (KR); Dong-Chun Kim, Seoul (KR)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 09/886,620

(22) Filed: Jun. 22, 2001

(30) Foreign Application Priority Data
Jun. 23, 2000 (KR) 2000-34783

(51) Int. Cl. H01M 4/96; H01M 4/88; C25D 3/50

(52) U.S. Cl. 429/44; 502/101; 205/159; 205/224

(57) ABSTRACT

Disclosed herein is a method of fabricating a catalyzed porous electrode for fuel cell, which electrode can be fabricated in a simple and easy manner without forming a catalyst support layer of carbon particles, and has an excellent, stable catalytic efficiency. The method comprises treating an electrically conductive, porous carbon substrate with an oxidizing agent; making one face of the porous carbon substrate in contact with an electrodeposition solution As containing ions of a catalytic metal; applying a pulsed potential to the electrodeposition solution to deposit the catalytic metal on the porous substrate, thereby catalyzing the porous substrate; and heat-treating the catalyzed porous substrate.

### BACKGROUND OF THE INVENTION

1. Field of the Invention

The present invention relates in general to electrodes for fuel cells and a method of fabricating the same. More particularly, it relates to a method of fabricating catalyzed carbon electrodes for direct methanol fuel cells by electrodepositing catalysts directly on porous carbon substrates, and to electrodes fabricated thereby.

2. Description of the Prior Art

Generally, fuel cells provide highly efficient sources of electrical power with reduced pollution, which transform chemical energy of fuels directly to electrical energy. The fuel cells have been continuously studied for use as general sources of electrical power since they had developed long time ago as sources of electrical power for a spaceship in the United States of America. The fuel cells are classified into an alkali type, a molten carbonate type and a solid polymer type depending on particular electrolytes used. Among these fuel cells, the solid polymer electrolyte fuel cell particularly has no risks of corrosion or evaporation caused by an electrolyte by virtue of use of a solid polymer as the electrolyte. Also, this solid polymer electrolyte fuel cell can achieve high current density per unit area and thus is high in output characteristic and energy conversion efficiency. In addition, it can be operated at room temperature, decreased in size and sealed. Therefore, active studies are progressed to apply the solid polymer electrolyte fuel cell in fields of battery cars, home power generator systems, equipment for mobile communications, medical devices, military installations, equipment for the space industry, and the like.

Fuels used in the fuel cells include hydrocarbons, hydrogen gas, and alcohols such as methanol. In particular, the so-called direct methanol fuel cell (DMFC) using methanol as a fuel can be operated at low temperature because of supply of the liquid fuel. Also, such a direct methanol fuel cell is easy to be moved, and does not require fuel reformers. By virtue of these advantages, the direct methanol fuel cell is a power generator system attended as an alternate energy source of future generations. In the direct methanol fuel cell, methanol is oxidized at a fuel electrode (negative electrode), and oxygen is supplied in a gaseous phase and reduced at an oxygen electrode (positive electrode). This oxidation-reduction reaction in the fuel cell is represented by the following reaction equation:

Fuel electrode; CH₃OH+H₂O=CO₂+6H+6e⁻, E⁰=0.043V

Air electrode: 3/2 O₂+6H⁺+6e⁻=3H₂O, E⁰=1.229V

Overall reaction: CH₃OH+3/2 O₂=CO₂+2H₂O, E⁰=1.186V

A key element of the fuel cell is a membrane electrode assembly (MEA). The membrane electrode assembly consists of a solid polymer electrolyte, as an ion conducting membrane, and two catalyzed electrodes adjacent thereto, The electrodes deposited with catalysts are generally consists of a substrate, a diffusing layer and an active catalytic layer. The substrate made of a carbon cloth or a carbon paper serves as a first collector, a layer of carbon powders applied on the substrate serves as a diffusing layer of diffusing the supplied fuel, and a layer of carbon powders having a catalyst supported thereon is applied on the diffusing layer and serves as a catalytic layer.

A well-known catalyst type used in forced circulation methanol fuel cells is platinum or platinum alloy, which is coated on carbon particles by a wet chemical method, such as a reduction of platinum chloride, This type of catalyst is bonded on the carbon powder layer, which is bonded on the carbon paper using a binder, such as polytetrafluoroethylene (PTFE). These carbon particles of a carbon powder shape provide an electrical conductivity. Meanwhile, in a manner of coating a catalytic metal on the polymer electrolyte without the support particles, a catalytic metal salt is reduced in an organic solution and then sprayed to make a catalytic electrode. Alternatively, the catalytic metal salt may also be mixed directly into a solution containing the polymer electrolyte and be deposited on the substrate.

In the forced circulation fuel cell, the membrane electrode assembly is fabricated using the electrodes made according to the methods described above. The membrane electrode assembly fabricated by such prior methods needs to be subjected to a pressure procedure to make an ohmic contact between the substrate, the diffusing layer, the catalyst layer and the polymer electrolyte member. In the unit fuel cell thus fabricated, the fuel is passed through the carbon substrate (carbon paper), as the first collector, to the diffusing layer made of carbon powders. The fuel passed through the diffusing layer is supplied to the active catalyst layer and subjected to an electrochemical oxidation-reduction reaction. This electrode structure cannot significantly matter with respect to the forced circulation fuel cell. In a self-breathing fuel cell in which fuel is supplied by pure diffusion, however, the fuel is passed through limited pathways due to a non-uniformity of the active catalyst layer. For this reason, the self-breathing fuel cell is disadvantageous in that a large amount of catalyst can be present in an inactive state, and hydrogen ions produced from a portion of catalyst being not in contact with the electrolyte film, i.e., a portion of catalyst contained in the inner part of the active catalyst layer, cannot be moved effectively to a negative electrode. The ineffective movement of hydrogen ions in the fuel cell results in an increase in internal resistance and deteriorates a performance of fuel cell. Ideal electrodes in the direct methanol fuel cell are ones having a structure in which the supply of fuel and the discharge of carbon dioxide produced are easily achieved and the migration of hydrogen ions produced is easily effected.

Accordingly, the structure of the electrodes needs to be designed in such a manner that the supply of fuel and the discharge of products become easy by selection of supports having suitable specific areas, and the migration of hydrogen ions produced becomes easy by positioning the catalyst as close as possible to the face being in contact with an electrolyte. Considering these characteristics, a method of depositing a noble catalytic metal onto gas diffusion electrodes is disclosed in U.S. Pat. No. 5,084,144 to Vilambi Reddy et al. In this patent, fine particles of a catalytic metal are deposited onto an uncatalyzed layer of carbon particles. Pulsed direct current is applied to the carbon particles bonded with a fluorocarbon resin and impregnated with a hydrogen ion exchange resin to deposit the noble catalytic metal. However, the method disclosed in this patent includes the step of forming a catalyst support layer of carbon particles on a carbon paper substrate, as well as the step of impregnating the ion exchange polymer into the catalyst support layer, and thus is relatively complicated in electrode-fabricating process. Also, the electrodes fabricated by the method disclosed in this patent have the carbon particle layer, and thus are relatively complicated in electrode structure. Such complications in the electrode-fabricating process and the electrode structure contribute to the expensive price of the fuel cell.

Meanwhile, U.S. Pat. No. 6,080,504 to Taylor et al. discloses a method including applying a pulsed electric current to gas diffusion electrodes, thereby depositing catalytic metals in the gas diffusion electrodes in amounts greater than hitherto achieved, while retaining the small particle size and electronic and ionic accessibility that provides high mass activity. This Taylor patent shows that use of the pulsed electric current in an electrodepositing step allows the noble catalytic metals to be deposited in nanometer sizes. In carrying out the electrodepositing process, the two-electrode system generally utilizes the application of pulsed electric current, and the three-electrode system can utilize pulsed electric potential and pulsed electric current. However, as the electrodedeposition is based on the electrochemical reduction potential, the potential can be controlled in an easy manner. In the three-electrode system, a counter electrode is used additionally to the two-electrode system, so that a potential stability of a reference electrode can be assured and the potential can be accurately controlled. However, the method disclosed in this Taylor patent includes the step of forming a catalyst support layer of carbon particles on a carbon paper substrate, so that an electrode-fabricating process is relatively complicated. Also, the electrodes produced by the method disclosed in this patent have the carbon particle layer, and thus are relatively complicated in electrode structure. Such complications in the electrode-producing process and the electrode structure contribute to the expensive price of the fuel cell.

### SUMMARY OF THE INVENTION

It is therefore an object of the present invention to overcome the above-described shortcomings with the prior art and to provide a method of fabricating a catalyzed porous carbon electrode in a simple and easy manner by electrodepositing a catalytic metal directly on a porous carbon substrate without forming the catalyst support layer of carbon particles.

It is also an object of the present invention to provide a method of fabricating a catalyzed porous carbon electrode having an excellent, stable catalytic efficiency.

The present invention provides a method of fabricating a catalyzed porous carbon electrode for a fuel cell, which comprises the steps of treating an electrically conductive, porous carbon substrate with an oxidizing agent; making one face of the porous carbon substrate in contact with an electrodeposition solution containing ions of a catalytic metal; applying a pulsed potential to the electrodeposition solution to deposit the catalytic metal on the porous substrate, thereby catalyzing the porous substrate; and heat-treating the catalyzed porous substrate.

### BRIEF DESCRIPTION OF THE INVENTION

The above and other objects and aspects of the invention will be apparent from the following description of embodiments with reference to the accompanying drawings, in which:

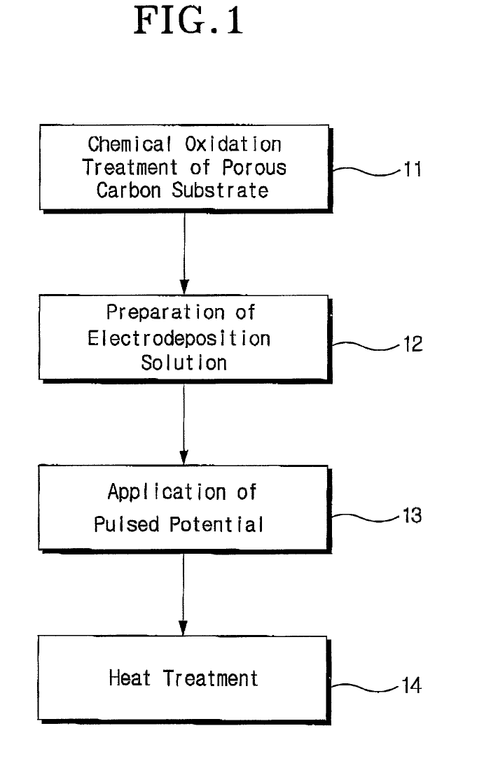

FIG. 1 is a process flow chart showing a method of fabricating a catalyzed porous carbon electrode according to the present invention;

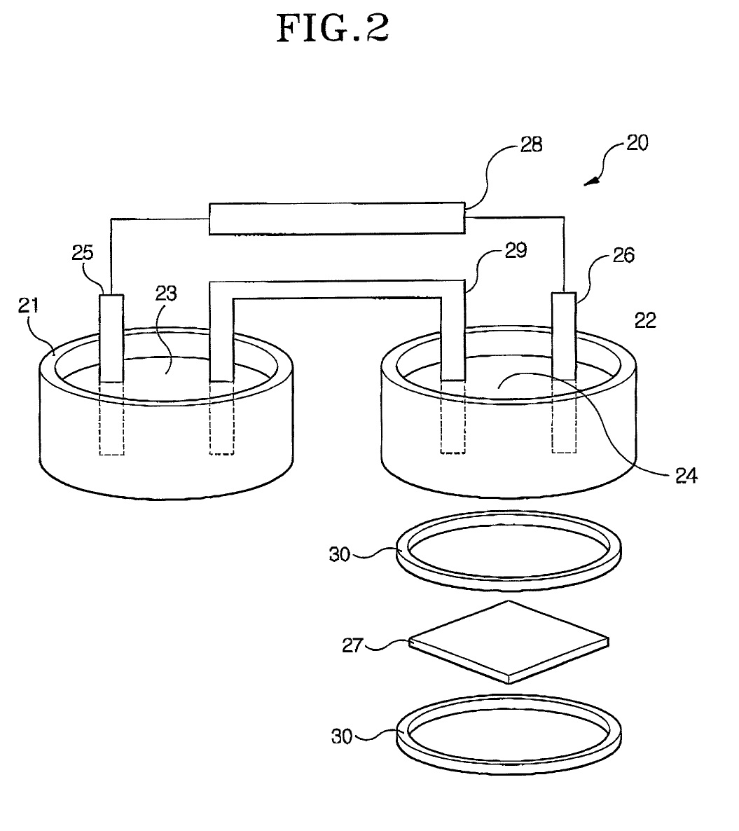

FIG. 2 schematically shows an electrodepositing apparatus used in the method of the present invention;

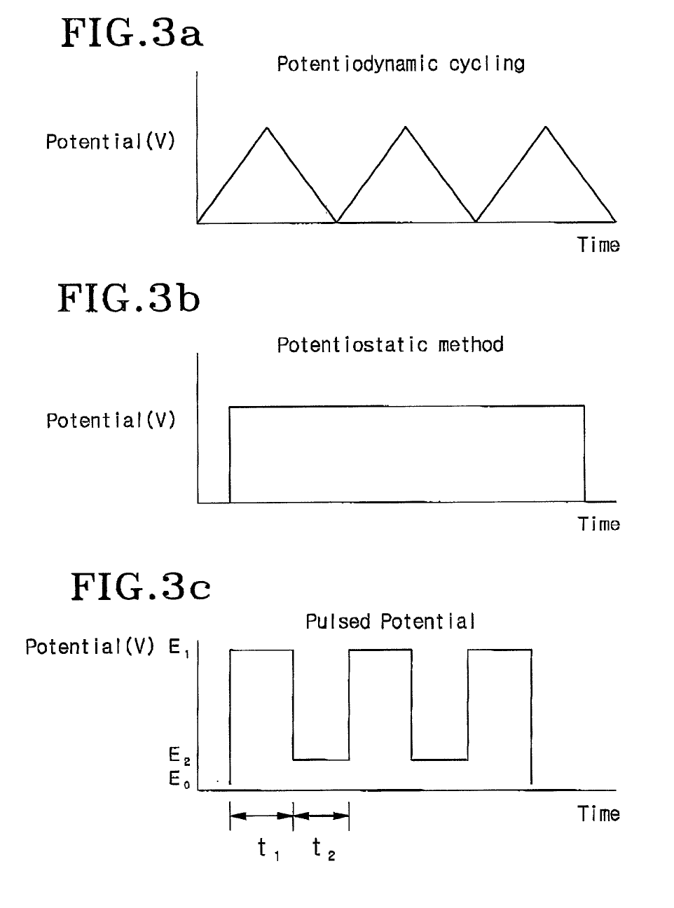

FIG. 3 illustrates various methods of applying potential applications, in which

FIG. 3a illustrates a method of electrodepositing a particulate catalytic metal while changing the potential at a constant rate;

FIG. 3b illustrates a method of applying a constant potential during the electrodeposition; and

FIG. 3c illustrates a method of applying a pulsed potential used in the method of the present invention;

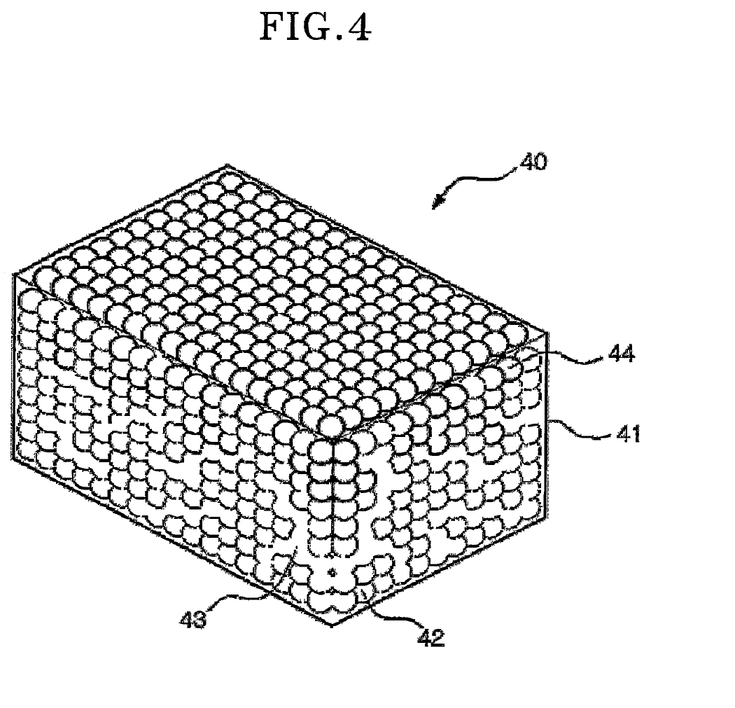

FIG. 4 schematically shows an inner structure of a catalyzed porous carbon electrode fabricated according to the method of the present invention;

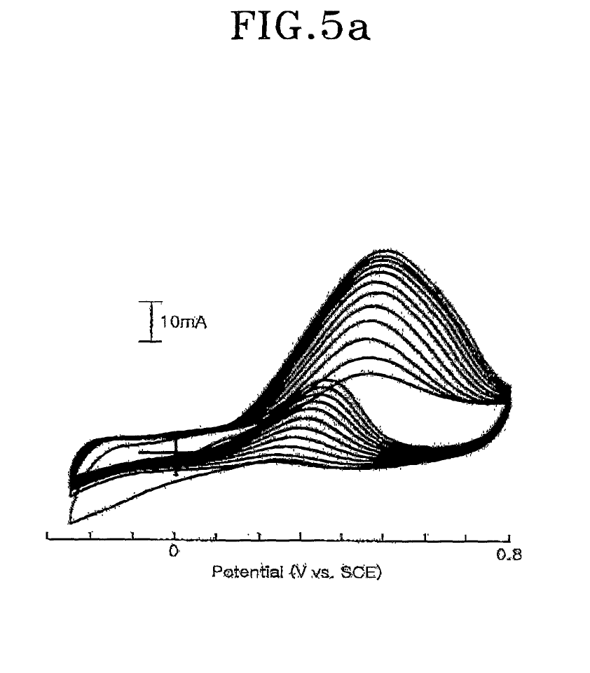

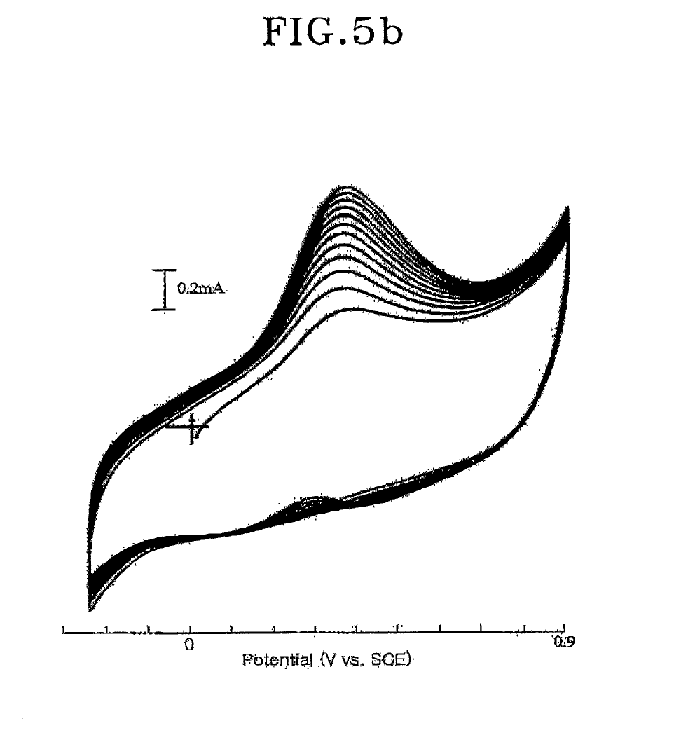

FIG. 5a and 5b show cyclic voltammograms measured for a porous carbon electrode deposited with a platinum/ruthenium catalyst;

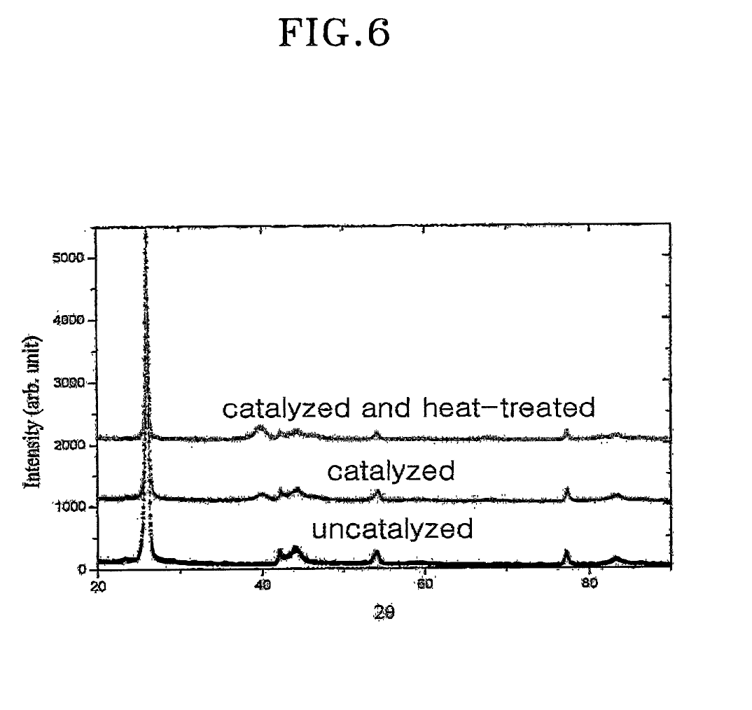

FIG. 6 shows XRD spectra measured for a non-catalyzed porous carbon substrate, a catalyzed porous carbon substrate fabricated according to the method of the present invention, and a catalyzed, heat-treated porous carbon electrode fabricated according to the method of the present invention; and

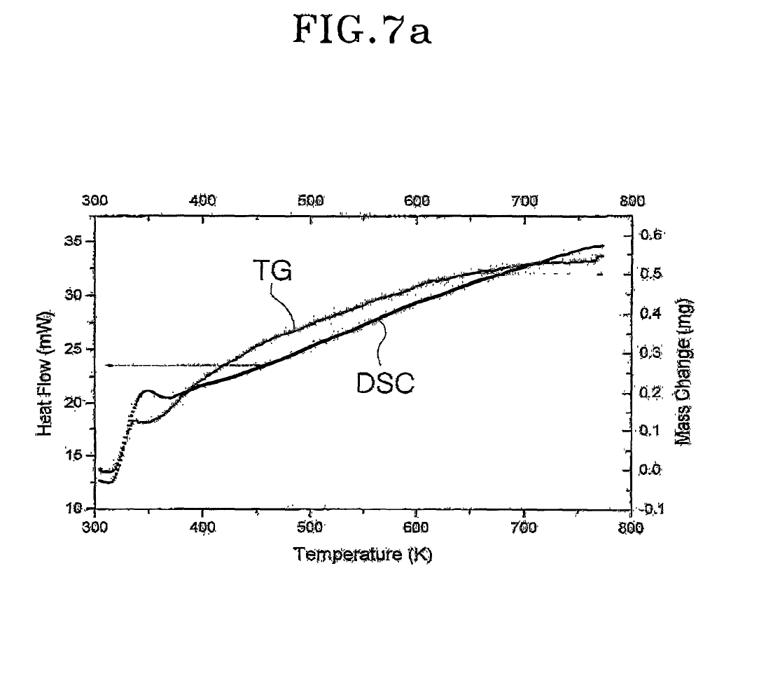

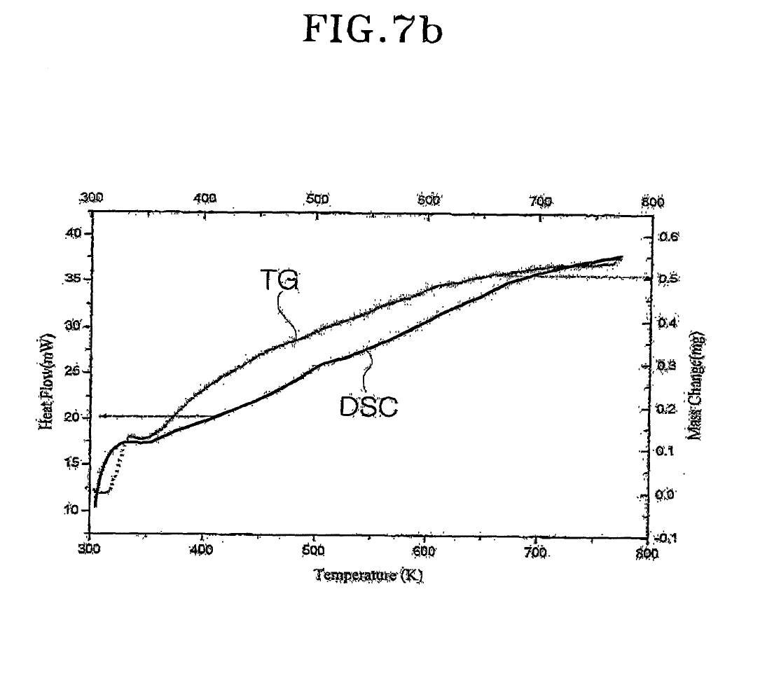

FIG. 7a and FIG. 7b show a differential scanning calorimetry (DSC) spectrum and a thermogravimetry (TG) spectrum measured for a uncatalyzed porous carbon substrate, and a DSC spectrum and a TG spectrum measured for a porous carbon substrate deposited with a platinum/ruthenium catalyst, respectively.

### DETAILED DESCRIPTION OF THE INVENTION

FIG. 1 is a process flow chart showing a method of fabricating a catalyzed porous carbon electrode according to the present invention. As shown in FIG. 1, an electrically conductive porous carbon substrate is first treated with an oxidizing agent. Here, the porous carbon substrate preferably has a porosity ranging from 5% to 30%. This is because a porosity above 30% results in an increase in internal resistance to make collecting of electric current inefficient, whereas a porosity below 5% results in a decrease in spatial deposition area of a catalyst and causes a reduction in electrode efficiency. The treatment step using the oxidizing agent includes chemically surface-treating the porous carbon substrate with the oxidizing agent More specifically, the treatment with the oxidizing agent includes subjecting the porous carbon substrate immersed in an oxidizing agent-containing solution to a sonication. This treatment provides the removal of impurities present on the surface and inner part of the porous carbon substrate, and produces the formation of defects on the porous carbon substrate, which defects act as nuclei upon electrodeposition of catalysts to make the electrodeposition easy. Also, as the catalyst of the fuel cell electrode is generally present on the porous carbon substrate in a physically adsorbed state, it can be separated from the surface of the porous carbon substrate depending on supply conditions of fuel and conditions of the fuel cell. In a manner of solving this problem, the porous carbon substrate is oxidized in the oxidizing agent-containing solution (e.g., nitric acid solution) at its surface and inner part, to thereby produce functional groups such as carboxyl group at the oxidized sites. These oxidized sites act as nuclei upon electrodeposition of catalysts, so that catalytic particles are first chemically adsorbed to form a monomolecular layer on which catalytic metal particles are deposited upon electrodeposition. Thus, as the catalytic metal can be bonded on the porous carbon substrate in a more stable manner, a phenomenon where the catalytic metals are separated from the surface of the carbon substrate can be reduced. In addition, there is made a fundamental ohmic contact between the catalytic layer and the carbon substrate to thereby decrease an electric current loss. The oxidizing agent, which can be used in the oxidizing-treatment step of the substrate, includes nitric acid, hydrogen peroxide, and potassium manganate. Also, in the oxidation treatment step, the oxidizing agent is used in a solution, a concentration of the oxidizing agent in a solution is in the range of 0.1 to 5 M, a treating temperature ranges from 30 to 80° C., and a treating time is over 0.5 to 2 hours.

In a subsequent step, a precursor containing ions of a catalytic metal is dissolved in a solvent to form an electrodeposition solution. The catalytic metal is selected from the group consisting of titanium (Ti), Vanadium (V), chromium (Cr), manganese (Mn), iron (Fe), cobalt (Co), nickel (Ni), zinc (Zn), aluminum (Al), molybdenum (Mo), selenium (Se), tin (Sn), platinum (Pt), ruthenium (Ru), palladium (Pa), tungsten (W), iridium (Ir), osmium (Os), rhodium (Rh), niobium (Nb), tantalum (Ta), lead (Pb) and alloys thereof. The solvent is preferably pure water. Also, the electrodeposition solution contains a hydrophobic solute so as to be infiltrated into the inner part of the porous carbon substrate. The hydrophobic solute includes alcohols, such as methanol, ethanol or isopropanol, and is preferably used at the amount of 0.5% by volume to 5% by volume relative to the volume of the solvent. Further, the electrodeposition solution may contain an acid or base so that the catalytic metal particles are deposited onto the porous carbon substrate in a more stable state. The acid or base is preferably used at the amount of about 0.5% by volume to 2% by volume relative to the solvent volume.

FIG. 2 shows an apparatus for carrying out the electrodeposition using the porous carbon substrate thus oxidation-treated and the electrodeposition solution thus prepared. In FIG. 2 showing an electrodepositing apparatus 20, a porous carbon substrate 27, as a working electrode, is deposed in a lower portion of a first electrolytic bath 22 in such a manner that one face of the substrate is in contact with an electrodeposition solution 24, Meanwhile, O-rings 30 are disposed at a upper face-side and a lower face-side of the porous carbon substrate, to thereby prevent the electrodeposition solution 24 from leaking. A counter electrode 26 is conductive and has a 1.5 times larger area than the porous carbon substrate 27. The porous carbon substrate 27 has a porosity of 5% to 30%, and an electrical resistance of 0.01 to 10 Ω, and preferably 0.4 to 2 Ω. The electrodepositing apparatus used in the present invention is the three-electrode system in which a saturated KCl electrolytic solution 23 and a reference electrode 25 are contained in a second electrolytic bath 23, and the electrodeposition solution 24 and the counter electrode 26 are contained in the first electrolytic bath 22. The reference electrode 25, the counter electrode 26 and the working electrode 27 are connected to a pulsed potential-supply source 28, respectively, Also, a salt bridge 29 is used to protect the reference electrode 25 from contamination with the electrodeposition solution 24. The three-electrode system minimizes a change in reference electrode potential caused by IR drop generated upon supply of external electric power, as compared to the two-electrode system. That is, the measurement of an electrode potential in a solution requires the measurement of a potential difference between two points. To the working electrode as a measuring electrode is connected another electrode, and the potential difference is measured. Where external voltage is applied between the electrodes, the IR drop is generated between the electrodes so that the reference electrode potential deviates from an equilibrium value. To avoid this error, the three-electrode system is used which consists of the working electrode 27, the counter electrode 26 and the reference electrode 25. In this three-electrode system, fuel cell current flows between the working electrode and the counter electrode, whereas there is little or no current passed between the working electrode and the reference electrode. By doing so, a potential difference between the working electrode and the reference electrode can be preciously controlled regardless of an applied electric current value.

Thereafter, a pulsed potential is applied to the electrodeposition solution in the electrodepositing apparatus thus structured, so that catalytic metal particles are deposited onto the surface and inner part of the porous carbon substrate. FIG. 3 shows various methods of applying a potential. FIG. 3a illustrates a method of electrodepositing a catalytic metal particle while changing the potential at a constant rate; FIG. 3b illustrates a method of applying a constant potential during the electrodeposition; and FIG. 3c illustrates a pulsed potential method in which two potentials within a desired potential region are applied alternately to the working electrode, thereby electrodepositing the catalytic metal particles. This pulsed potential applying method has a definite difference from the pulsed electric current applying method, in that the electric current is always passed during the electrodeposition although the quantity of the electric current is varied. As shown in FIG. 3c, the pulsed potential applying procedure comprises applying, continuously for an electrodeposition time (t), cyclic pulses including an initial potential (E₀), an upper limit potential (E₁) for a time (t₁) and a lower limit potential (E₁) for a time (t₂) A cyclic time (T) for the pulsed potential is t₁+t₂. It is preferred for the present invention that t₁ is selected within the range of 1 to 30 seconds, t₁/t₂ is selected within the range of 0.1 to 1, the range of 1 to 5, or the range of 0.01 to 5, and E₁ is more negative or positive with respect to E₂. A potential region, at which the catalytic metal is deposited, is in the range of −1.5 to 0.5 V with respect to the reference electrode. The loading amount of the catalytic metal is controlled by the quantity of charges, and it is preferred to pass charges of 0.01 to 10.0 c/cm². As the porous carbon substrate is somewhat hydrophobic, it absorbs a hydrophobic solution through fine pores without easily absorbing water. By this hydrophobic property, a thickness of a catalytic layer formed will be varied depending on an extent of the electrodeposition solution absorbed into the porous carbon substrate. This indicates that, if only water is used as a solvent, a catalytic metal will be deposited only on the surface of the porous carbon substrate. Where a hydrophobic solute is added to the electrodepositing solution at a small amount, however, the catalytic metal dissolved in the electrodeposition solution will be absorbed through the fine pores of the porous carbon substrate together with the hydrophobic solute. Ultimately, on a surface of carbon particles in the inner part of porous carbon substrate is deposited the catalytic metal, when the pulsed potential is applied to the porous carbon substrate. The hydrophobic solute added to the electrodeposition solution includes alcohols, such as methanol, ethanol, isopropanol, butanol, pentanol, hexanol, and the like, and is added at 0.5 to 5% by volume relative to the volume of the solvent.

A catalyzed porous carbon electrode, which was deposited with the catalytic metal by application of the pulsed potential, is schematically shown in FIG. 4 as the reference numeral 40. As shown in FIG. 4, the catalyzed porous carbon substrate 41 includes fine pores 43 through which the electrodepositing solution is sufficiently permeated into the inner part of the porous carbon substrate 41. Accordingly, where the porous carbon substrate in this state is applied with the pulsed potential, catalytic metal particles 44 are deposited electrolytically onto carbon particles 42 in the inner part of the porous carbon substrate 41. The pulsed potential applied provides a change in quantity and direction of the electric current passed with potential modulated, so that oxides (PtOₓ, RuOₓ, WOₓ) required in the fuel oxidation reaction are contained plentifully in the catalyst.

As described above, where the catalytic metal particles are deposited electrolytically onto the porous carbon substrate having the fine pores, the catalyst will be placed in locations acting as supply passages of fuel. Thus, the amount of inactive catalyst in the catalyzed electrode fabricated according to the present invention is significantly reduced as compared to that of the catalyzed electrodes fabricated according to the prior methods. In other words, if an electrode having a catalyst 44 supported on the porous carbon substrate 41 consisting of carbon particles 42 and fine pores 43 as shown in FIG. 4 is applied in the direct methanol fuel cell, methanol is then moved by diffusion from a thick concentration side toward a thin concentration side, i.e., toward a catalyst side. At this time, as the catalyst is supported on the surface and inner part of the porous carbon substrate, the fuel diffused in the porous carbon substrate is oxidized by the catalyst supported on the internal pores and by the catalyst supported on the surface of the porous substrate. Electrons produced from this oxidization are collected through the porous carbon substrate, and hydrogen ions are produced at positions near the polymer electrolyte membrane, and hence, more effectively transferred to the electrolyte. As a result, the porous carbon substrate, which was catalyzed at only one face, functions as a gas diffusing layer, a collecting layer and a catalyst-coated active layer.

A subsequent step is a step of heat-treating the catalyzed porous carbon substrate deposited with the catalytic metal. This heat-treatment is carried out at a temperature of 500 to 650 K for 0.5 to 2 hrs. Also, a temperature elevation rate is in the rage of 1 to 10° C./min. After heat-treating, the catalyzed porous substrate is cooled in air.

The following examples are for further illustration purposes only and in no way limit the scope of this invention.

### EXAMPLE 1

### Oxidation Treatment of Porous Carbon Substrate

A porous carbon substrate is immersed in a 5M nitric acid solution and subjected to a sonication at about 60° C. for about 30 minutes. Then, the porous substrate is washed with pure water, immersed in a 0.5M nitric acid solution again, and subjected to a sonication at about 40° C. for about 30 minutes. Next, the porous carbon substrate is washed with pure water, and then subjected to an ultrasonic cleaning in pure water at about 30° C. After measuring a pH of the cleaning solution used, the ultrasonic cleaning is repeated until the measured pH value becomes neutral.

### EXAMPLE 2

### Oxidation Treatment of Porous Carbon Substrate

A porous carbon substrate is immersed in a 5M hydrogen peroxide solution and subjected to a sonication at about 80° C. for about 2 hours. Then, the porous substrate is washed with pure water, immersed in a 0.5M hydrogen peroxide solution again, and subjected to a sonication at about 40° C. for about 30 minutes. Next, the porous carbon substrate is washed with pure water, and then subjected to an ultrasonic cleaning in pure water at about 30° C. for 10 minutes. After measuring a pH of the cleaning solution used, the ultrasonic cleaning is repeated until the measured pH value becomes neutral.

### EXAMPLE 3

### Electrodeposition of Platinum

The porous carbon substrate, which was oxidation-treated according to Example 1, is placed in an electrolytic bath containing a counter electrode. Then, a platinum electrodeposition solution consisting of a 0.02 M H₂PtCl₆ solution, to which about 1 volume e of a 0.1M HCl solution and about 0.5 volume % of ethanol were added, is introduced into the electrolytic bath in such a manner that it is in contact with one surface of the porous carbon substrate. Next, a rectangular pulsed potential in a potential region of −0.5 to 0.0 V with respect to a reference electrode (SCE) is applied to the electrodeposition solution to pass total charges of 0.1 to 10 C/cm³, thereby depositing a platinum catalyst onto the porous carbon substrate The catalyzed porous carbon substrate is washed well with water and then subjected to a heat treatment.

### EXAMPLE 4

### Electrodeposition of Platinum

The porous carbon substrate, which was oxidation-treated according to Example 2, is placed in an electrolytic bath containing a counter electrode. Then, a platinum electrodepositing solution consisting of a 0.5M (NH₄)₂PtCl₆ solution, to which about 3 volume % of a 0.1M NH₄Cl solution and about 2 volume % of ethanol were added, is introduced into the electrolytic bath in such a manner that it is in contact with one surface of the porous carbon substrate. Next, a pulsed potential in a potential region of −0.5 to 0.0 V with respect to a reference electrode (SCE) is applied to the electrodeposition solution to pass total charges of 0.1 to 10 C/cm³, thereby depositing a platinum catalyst onto the porous carbon substrate. The catalyzed porous carbon substrate is washed well with water and then subjected to a heat treatment.

### EXAMPLE 5

### Electrodeposition of Platinum/Ruthenium

The porous carbon substrate, which was oxidation-treated according to Example 1, is placed in an electrolytic bath containing a counter electrode. Then, a platinum/ruthenium electrodeposition solution consisting of a 0.05M H₂PtCl₆ solution and a 0.05M RuCl₃ solution, to which about 5 volume % of a 0.1M HCl solution and about 2 volume % of ethanol were added, is introduced into the electrolytic bath in such a manner that it is in contact with one surface of the porous carbon substrate. Next, a pulsed potential in a potential region of −0.5 to 0.3 V with respect to a reference electrode (SCE) is applied to the electrodeposition solution to pass total charges of 0.1 to 10 C/cm³, thereby depositing a platinum/ruthenium catalyst onto the porous carbon substrate. The catalyzed porous carbon substrate is washed well with water and then subjected to a heat treatment.

### EXAMPLE 6

### Electrodeposition of Platinum/Tungsten Oxide

The porous carbon substrate, which was oxidation-treated according to Example 1, is placed in an electrolytic bath containing a counter electrode. Then, an electrodeposition solution which consists of a 0.5M H₂PtCl₆ solution and a 0.5M tungsten/ethanol solution consisting of 30 volume % ethanol added to a tungsten solution dissolved in a 33% hydrogen peroxide solution and to which about 0.1 volume % of a 12M HCl solution was added, is introduced into the electrolytic bath in such a manner that it is in contact with one surface of the porous carbon substrate. Next, a pulsed potential in a potential region of −0.5 to 0.3 V with respect to a reference electrode (SCE) is applied to the electrodeposition solution to pass total charges of 0.1 to 10 C/cm³, thereby depositing a platinum/tungsten oxide catalyst onto the porous carbon substrate. The catalyzed porous carbon substrate is washed well with water and then subjected to a heat treatment.

### EXAMPLE 7

### Electrodeposition of Platinum/Ruthenium

The porous carbon substrate, which was oxidation-treated according to Example 1, is placed in an electrolytic bath containing a counter electrode. Then, a platinum/ruthenium electrodeposition solution consisting of a 0.05M (NH₄)₂PtCl₆ solution and a 0.05M (NH₄)₂RuCl₃ solution, to which about 1 volume % of a 3M NH₄Cl solution and about 2 volume % of ethanol were added, is introduced into the electrolytic bath in such a manner that it is in contact with one surface of the porous carbon substrate. Next, a pulsed potential in a potential region of −0.5 to 0.3 V with respect to a reference electrode (SCE) is applied to the electrodeposition solution to pass total charges of 0.1 to 10 C/cm³, thereby depositing a platinum/ruthenium catalyst onto the porous carbon substrate. The catalyzed porous carbon substrate is washed well with water and then subjected to a heat treatment.

### EXAMPLE 8

### Electrodeposition of Platinum/Iridium/Osmium

The porous carbon substrate, which was oxidation-treated according to Example 2, is placed in an electrolytic bath containing a counter electrode. Then, a platinum/iridium/osmium electrodeposition solution consisting of a 0.02M H₂PtCl₆ solution, a 0.01M H₂IrCl₆ solution and a 0.05H₂OsCl₆ solution, to which about 5 volume e of a 1M HCl solution and about 2 volume % of ethanol were added, is introduced into the electrolytic bath in such a manner that it is in contact with one surface of the porous carbon substrate. Next, a pulsed potential in a potential region of −1.5 to 0.3 V with respect to a reference electrode (SCE) is applied to the electrodeposition solution to pass total charges of 0.1 to 10 C/cm³, thereby depositing a platinum/iridium/osmium catalyst onto the porous carbon substrate. The catalyzed porous carbon substrate is washed well with water and then subjected to a heat treatment.

### EXAMPLE 9

### Electrodeposition of Platinum/Iridium/Osmium/Ruthenium

The porous carbon substrate, which was oxidation-treated according to Example 1, is placed in an electrolytic bath containing a counter electrode. Then, a platinum/iridium/osmium/ruthenium electrodeposition solution consisting of a 0.05M H₂PtCl₆ solution, a 0.01M H₂IrCl₆ solution, a 0.01M H₂OsCl₆ solution and a 0.05M RuCl₆ solution, to which about 5 volume % of a 1M HCl solution and about 2 volume % of ethanol were added, is introduced into the electrolytic bath in such a manner that it is in contact with one surface of the porous carbon substrate. Next, a pulsed potential in a potential region of −1.2 to 0.3 V with respect to a reference electrode (SCE) is applied to the electrodeposition solution to pass total charges of 0.1 to 10 C/cm³, thereby depositing a platinum/iridium/osmium/ruthenium catalyst onto the porous carbon substrate. The catalyzed porous carbon substrate is washed well with water and then subjected to a heat treatment.

### EXAMPLE 10

### Electrodeposition of Platinum/Iridium/Osmium/Ruthenium

The porous carbon substrate, which was oxidation-treated according to Example 2, is placed in an electrolytic bath containing a counter electrode. Then, a platinum/iridium/osmium/ruthenium electrodeposition solution consisting of a 0.02M (NH₄)₂PtCl₆ solution, a 0.01M (NH₄)₂IrCl₆ solution, a 0.01M (NH₄)₂OsCl₆ solution and a 0.02M (NH₄)₂RuCl₆ solution, to which about 5 volume % of a 1M HCl solution and about 2 volume % of ethanol were added, is introduced into the electrolytic bath in such a manner that it is in contact with one surface of the porous carbon substrate. Next, a pulsed potential in a potential region of −1.2 to 0.3 V with respect to a reference electrode (SCE) is applied to the electrodeposition solution to pass total charges of 0.1 to 10 C/cm³, thereby depositing a platinum/iridium/osmium/ruthenium catalyst onto the porous carbon substrate. The catalyzed porous carbon substrate is washed well with water and then subjected to a heat treatment.

### EXAMPLE 11

The porous carbon substrate coated with the platinum/ruthenium catalyst according to Example 5 was measured for a cyclic voltammogram in a mixed solution of a 0.5M sulfuric acid (H₂SO₄) solution and a 0.1M methanol (MeOH) solution. Results are shown in FIGS. 5a and 5b. FIG. 5a is a curve showing the results of the measurement carried out for the porous carbon substrate having the platinum/ruthenium catalyst layer deposited according to Example 5, and FIG. 5b is a curve showing the results of the measurement carried out in a state where the deposited platinum/ruthenium layer was removed by about 300 μm. From comparison of the results of FIG. 5a with the results of FIG. 5b, it could be found that the porous carbon substrate was catalyzed with platinum/ruthenium to its inner part.

### EXAMPLE 12

A variety of platinum/ruthenium-catalyzed electrodes fabricated under different conditions were measured for a current density from methanol oxidation. Results are shown in Table 1.

TABLE 1

| Sample | Passed | | Oxidizing | | Heat | |
|---|---|---|---|---|---|---|
| No. | Charge (C) | Solvent | Agent | Sonication | treatment | I(mA/cm²)^{a} |
| 1 | 1.3 | ethanol/water | | | | 15 |
| 2 | 1.3 | ethanol/water | | | Yes | 16 |
| 3 | 1.4 | ethanol/water | Yes | | | 18 |
| 4 | 1.4 | ethanol/watar | Yes | Yes | | 22 |
| 5 | 1.4 | ethanol/water | Yes | Yes | Yes | 26 |
| 6 | 4.0 | Water | | | Yes | 22 |
| 7 | 4.0 | ethanol/water | | | Yes | 25 |

^{a}methanol oxidation current density at 0.5 V

From Table 1 above, it could be found that the porous carbon substrates subjected to the oxidation treatment, the sonication (during the oxidation treatment) and the heat treatment have exhibited an increase in methanol oxidation current density by 60 to 70%, as compared to the substrates not subjected to the above treatments. This indicates that treating the porous carbon substrate with the oxidizing agent prior to carrying out the electrodeposition of the catalyst is significantly critical. Similar results were also observed for other catalytic materials. Where the catalyst in the solution containing the hydrophobic solute was deposited onto the porous carbon substrate treated in the nitric acid solution, a current density at 0.5V was 26 mA/cm² when a catalytic amount (i.e., quantity of charge consumed for deposition) was 1.4C/cm². On the other hand, in the cases of using the pure water solvent and the hydrophobic solute-containing solvent while using the porous carbon substrate not pre-treated with the oxidizing agent, the current densities at 0.5V were 22 mA/cm² and 25 mA/cm², respectively, when the catalytic amount was about 4 C/cm². The current density was increased as the potential was circulated. This is because, as fuel is diffused into the inner part of the porous carbon substrate, an oxidation occurs at the surface of the catalyst deposited on the inner part of the porous carbon substrate. Namely, this is because an active electrode area becomes wide. These results indicate that the catalyst was deposited onto the inner part of the porous carbon substrate as shown in FIG. 4, and a contact between the porous carbon substrate and the catalyst layer is an ohmic contact.

### EXAMPLE 13

The porous carbon substrates catalyzed according to procedures described in Examples 3-10 were tested for a methanol oxidation characteristic in a 0.5M sulfuric acid solution containing a 0.1M methanol solution Results are shown in Table 2 below.

TABLE 2

| Examples | Electrode position solution | ^{a}Eₚₑₐₖ | *I(mA/cm²) | ^{b}Crystal size(Å) |
|---|---|---|---|---|
| 3^{c} | H₂PtCl₆ | 0.65 | 19 | 16 |
| 4^{c} | (NH₄)₂PtCl₆ | 0.66 | 19 | 13 |
| 5 | H₂PtCl₆;RuCl₃ | 0.51 | 26 | 28 |
| 6 | H₂PtCl₆;WOₓ | 0.64 | 23 | 35 |
| 7 | (NH₄)₂PtCl₆; | 0.52 | 24 | |
| | (NH₄)₂RuCl₆ | | | |
| 8 | H₂PtCl₆;H₂IrCl₆;H₂OsCl₆ | 0.58 | 20 | |
| 9 | H₂PtCl₆;H₂IrCl₆;H₂OsCl₆;RuCl₃ | 0.53 | 24 | 30 |
| 10 | (NH₄)₂PtCl₆;(NH₄)₂RuCl₆; | 0.54 | 23 | |
| | H₂OsCl₆;(NH₄)₂IrCl₆; | | | |

^{a}methanol oxidation peak potential relative to SCE
*methanol oxidation current density at 0.5 V
^{b}crystal size evaluated from XRD
^{c}not heat-treated

As evident from Table 2, Example 5 having a Pt/Ru catalyst exhibited the most excellent characteristic in the methanol oxidation reaction. Meanwhile, the method of fabricating the catalyzed porous carbon electrode according to the present invention allows the catalytic metal to be used at a significantly reduced loading (0.6 mg of Pt—Ru/cm³) compared to the catalyst loading (about 4.5 mg of Pt—Ru/cm³) of the electrodes fabricated according to the prior methods.

Meanwhile, to measure a size of catalytic crystals deposited by pulsed potential applications, an X-ray diffraction (XRD) spectrum was measured for the uncatalyzed porous carbon substrate and the porous carbon substrate catalyzed with the platinum/ruthenium catalyst as in Example 5. Results are shown in FIG. 6. In FIG. 6, there can be found Pt/Ru-related peaks at 2θ values of 40, 47 and 68. The catalyst of the catalyzed porous substrate had a crystal size ranging from 13 to 35 Å as calculated from a full width half maximum (FWHM) of XRD with respect to a (220) plane having a 2θ value of 68. The catalyst crystal size calculated from XRD measured after heat-treating the catalyzed porous carbon substrate was in the range of 27 to 35 Å. It is generally reported that the catalyst has the most excellent activity at a crystal size of 20 Å.

Meanwhile, the heat treatment procedure is a critical factor in an activity of the catalyst deposited by pulsed potential applications. To establish a temperature for the heat treatment, DSC and TG analyses were carried out. DSC and TG spectra were measured for the uncatalyzed porous carbon substrate and the porous carbon substrate catalyzed with the platinum/ruthenium catalyst as in Example 5, respectively. Results are shown in FIGS. 7a and 7b. FIG. 7a shows a DSC spectrum and a TG spectrum measured for the uncatalyzed porous carbon substrate, and FIG. 7b shows a DSC spectrum and a TG spectrum measured for the catalyzed porous carbon substrate deposited with the platinum/ruthenium catalyst. Table 3 below shows temperatures at which changes in heat flow occur, according to catalytic components.

TABLE 3

| Catalytic component | Heat flow change temperature (K) |
|---|---|
| Pt | about 590 |
| Pt/Ru | about 530 |
| Pt/WO₃ | about 510 |

As indicated in Table 3, temperatures at which changes in heat flow occur, are 590 K with only platinum, 530 K with Pt/Ru, and 514 K with Pt/WO₃, As shown in FIG. 7a, the DSC and TG spectra measured for the uncatalyzed porous carbon substrate did not exhibit changes in mass and heat flow at an examined temperature region (300 to 700 K). The heat absorption at about 373 K is the absorption of heat necessary for evaporation of water contained in the sample. In the case of platinum, a peak observed at about 590 K is not related to the phase transition. And it is believed that Pt(OH)ₓ, Ru(OH)ₓ and W(OH)ₓ in the catalysts deposited by the pulsed potential applications absorb heat to form catalyst oxides. According to XPS examination results known hitherto, the electrodeposited catalysts are present in various oxidized states. Thus, the heat flow change temperatures indicated in Table 3 provide a standard of a temperature at which the catalyzed porous carbon electrode is heat-treated.

As apparent from the foregoing, the present invention provides the method of fabricating the catalyzed porous carbon electrode for fuel cell. The catalyzed porous carbon electrode fabricated according to the method of the present invention is excellent and stable in catalytic efficiency since the catalytic metal is electrodeposited directly onto the porous carbon substrate. Also, where the catalyzed porous carbon electrode fabricated according to the method of the present invention is used as an electrode of the membrane electrode assembly (MEA) for the direct methanol fuel cell (DMFC) in which fuel is supplied by natural circulation, it functions as a collector, a diffusing layer and a active catalyst layer. As a result, the method of the present invention provides the catalyzed porous carbon electrode not requiring the catalyst support layer of carbon particles that was introduced in the prior methods, and thus, it contributes to a simplification of the fabricating process and a decrease in price of the fuel cell.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A method of fabricating a catalyzed porous carbon electrode for a fuel cell, which comprises the steps of;
treating an electrically conductive, porous carbon substrate with an oxidizing agent;
making one face of the porous carbon substrate in contact with an electrodeposition solution containing ions of a catalytic metal;
applying a pulsed potential to the electrodeposition solution to deposit the catalytic metal on the porous carbon substrate, thereby catalyzing the porous carbon substrate; and
heat-treating the catalyzed porous carbon substrate.

2. The method of claim 1, in which the fuel cell is a direct methanol fuel cell.

3. The method of claim 1, in which the porous carbon substrate has a porosity of 5 to 30% and an electrical resistance of 0.01 to 10 Ω.

4. The method of claim 1, in which the oxidizing agent is selected from the group consisting of nitric acid (HNO₃), hydrogen peroxide (H₂O₂) and potassium manganate (KMnO₄).

5. The method of claim 1, in which the step of treating the porous carbon substrate with the oxidizing agent is carried out by chemically surface-treating the porous carbon substrate.

6. The method of claim 5, in which the chemical surface treatment is carried out in a solution containing the oxidizing agent at 0.1 to 5M, at a temperature of 30 to 80° C. for 0.5 to 2 hours.

7. The method of claim 6, in which the chemical surface treatment includes a sonication.

8. The method of claim 1, in which the catalytic metal is selected from the group consisting of titanium (Ti), Vanadium (V), chromium (Cr), manganese (Mn), iron (Fe), cobalt (Co), nickel (Ni), zinc (Zn), aluminum (Al), molybdenum (Mo), selenium (Se), tin (Sn), platinum (Pt), ruthenium (Ru), palladium (Pa), tungsten (W), iridium (Ir), osmium (Os), rhodium (Rh), niobium (Nb), tantalum (Ta), lead (Pb) and alloys thereof.

9. The method of claim 1, in which the electrodeposition solution contains water, as a solvent, and a hydrophobic solute.

10. The method of claim 9, in which the hydrophobic solute is alcohol selected from the group consisting of methanol, ethanol, isopropanol, butanol, pentanol, hexanol and combinations thereof, and is contained at the amount of 0.5 to 5% by volume relative to the volume of the solvent.

11. The method of claim 1, in which the electrodeposition solution contains an acid or base at the amount of 0.5 to 2% by volume relative to the volume of the solvent.

12. The method of claim 11 in which an upper limit potential of the pulsed potential is more negative with respect to a lower limit potential.

13. The method of claim 1, in which an upper limit potential of the pulsed potential is more positive with respect to a lower limit potential.

14. The method of claim 1, in which a ratio of a time of applying an upper limit potential to a time of applying a lower limit potential of the pulsed potential is in the range of 0.1 to 1.

15. The method of claim 1, in which a ratio of a time of applying upper limit potential to a time of applying a lower limit potential of the pulsed potential is in the range of 1 to 5.

16. The method of claim 1, in which a ratio of a time of applying an upper limit potential to a time of applying a lower limit potential of the pulsed potential is in the range of 0.01 to 0.1.

17. The method of claim 1, in which the step of applying the pulsed potential to the electrodeposition solution is carried out in an electrolytic bath containing the porous carbon substrate, the electrodeposition solution in contact with one face of the porous carbon substrate, and an electrode.

18. The method of claim 1, in which the step of heat-treating the porous carbon substrate deposited with the catalytic metal, is carried out at a temperature of 500 to 650 K for 0.5 to 2 hours.

19. A catalyzed porous electrode fabricated by the method as set forth any one of claims 1-18.
